(19) United States
(12) Patent Application Publication
(10) Pub. No.: US 2021/0306720 A1
(43) Pub. Date: Sep. 30, 2021

(54) Thermal Monitoring System and Method

(71) Applicant: Salt & Light Energy Equipment, LLC, Dallas, TX (US)

(72) Inventors: ADRIAN R. SANDOVAL, Orange Grove, TX (US); Joey Garcia, Allce, TX (US); Jesse Guerra, Banquete, TX (US)

(21) Appl. No.: 17/210,116

(22) Filed: Mar. 23, 2021

Related U.S. Application Data
(60) Provisional application No. 62/994,101, filed on Mar. 24, 2020.

(51) Int. Cl. H04Q 9/00; G01K 7/22; G01K 7/18; G01K 1/024; F04B 51/00; E21B 43/26

(52) U.S. Cl. CPC H04Q 9/00; G01K 7/22; G01K 7/18; H04Q 2209/40; F04B 51/00; E21B 43/2607; H04Q 2209/30; G01K 1/024

(57) ABSTRACT

A thermal monitoring system includes: one or more thermal sensors configured to monitor the temperature of one or more portions of a fracking pump and generate one or more thermal indication signals; a processing system configured to receive the one or more thermal indication signals and associate the one or more thermal indication signals with one or more operating temperatures of the one or more portions of the fracking pump; and an indication system configured to provide a thermal condition indicator based, at least in part, upon the one or more operating temperatures of the one or more portions of the fracking pump.

### RELATED APPLICATION(S)

This application claims the benefit of U.S. Provisional Application No. 62/994,101, filed on 24 Mar. 2020, the entire contents of which are incorporated herein by reference.

### TECHNICAL FIELD

This disclosure relates to thermal monitoring systems and, more particularly, to thermal monitoring systems for use within fracking systems.

### BACKGROUND

As is known in the art, fracking is a well stimulation technique involving the fracturing of bedrock formations using a pressurized liquid. The fracking process involves the high-pressure injection (@ 10,000-14,000 PSI) of fracking fluid (primarily water, containing sand or other proppants suspended with the aid of thickening agents) into a well bore to create fractures in the deep-rock formations through which natural gas and petroleum will flow more freely. When the hydraulic pressure is removed from the well bore, small grains of hydraulic fracturing proppants hold the fractures open, thus allowing the continued flow of the natural gas and petroleum from the bore.

A fracking pump may include a plurality of plungers that are configured to pressurize fracking fluid that is received from a fracking fluid supply. As would be expected, these fracking pumps may overheat during use. And left unnoticed, such overheating may damage the fracking pump and potentially injury people proximate the same.

### SUMMARY OF DISCLOSURE

In one implementation, a thermal monitoring system includes: one or more thermal sensors configured to monitor the temperature of one or more portions of a fracking pump and generate one or more thermal indication signals; a processing system configured to receive the one or more thermal indication signals and associate the one or more thermal indication signals with one or more operating temperatures of the one or more portions of the fracking pump; and an indication system configured to provide a thermal condition indicator based, at least in part, upon the one or more operating temperatures of the one or more portions of the fracking pump.

One or more of the following features may be included. The one or more thermal sensors may be positioned proximate one or more plungers within the fracking pump. The one or more thermal sensors may be positioned proximate one or more packing assemblies associated with the one or more plungers within the fracking pump. The one or more thermal sensors may include one or more thermistor-based thermal sensors. The one or more thermal indication signals may include one or more resistance-based thermal indication signals. The one or more thermal sensors may include one or more thermocouple-based thermal sensors. The one or more thermal indication signals may include one or more voltage-based thermal indication signals. The indication system may include one or more thermal operating range indicators. The indication system may include one or more temperature indicators. The processing system may be configured to store temporal data based, at least in part, upon the one or more operating temperatures of the one or more portions of the fracking pump. The processing system may be configured to provide the temporal data to a remote computing device. The processing system may be configured to provide the one or more operating temperatures to a remote computing device. The processing system may be configured to provide the one or more operating temperatures to a remote computing device via a text message. The processing system may be configured to provide the one or more operating temperatures to a remote computing device via an email.

In another implementation, a thermal monitoring system includes: one or more thermal sensors configured to monitor the temperature of one or more portions of a fracking pump and generate one or more thermal indication signals, wherein the one or more thermal sensors are positioned proximate one or more plungers within the fracking pump; a processing system configured to receive the one or more thermal indication signals and associate the one or more thermal indication signals with one or more operating temperatures of the one or more portions of the fracking pump; and an indication system configured to provide a thermal condition indicator based, at least in part, upon the one or more operating temperatures of the one or more portions of the fracking pump, wherein the indication system includes one or more thermal operating range indicators.

One or more of the following features may be included. The one or more thermal sensors may be positioned proximate one or more packing assemblies associated with the one or more plungers within the fracking pump. The processing system may be configured to provide the one or more operating temperatures to a remote computing device. The processing system may be configured to provide the one or more operating temperatures to a remote computing device via a text message. The processing system may be configured to provide the one or more operating temperatures to a remote computing device via an email.

In another implementation, a thermal monitoring system includes: one or more thermal sensors configured to monitor the temperature of one or more portions of a fracking pump and generate one or more thermal indication signals, wherein: the one or more thermal sensors are positioned proximate one or more packing assemblies associated with one or more plungers within the fracking pump, the one or more thermal sensors include one or more thermocouple-based thermal sensors, and the one or more thermal indication signals include one or more voltage-based thermal indication signals; a processing system configured to receive the one or more thermal indication signals and associate the one or more thermal indication signals with one or more operating temperatures of the one or more portions of the fracking pump; and an indication system configured to provide a thermal condition indicator based, at least in part, upon the one or more operating temperatures of the one or more portions of the fracking pump, wherein the indication system includes one or more thermal operating range indicators.

One or more of the following features may be included. The processing system may be configured to store temporal data based, at least in part, upon the one or more operating temperatures of the one or more portions of the fracking pump. The processing system may be configured to provide the temporal data to a remote computing device. The processing system may be configured to provide the one or more operating temperatures to a remote computing device. The processing system may be configured to provide the one or more operating temperatures to a remote computing device via a text message. The processing system may be configured to provide the one or more operating temperatures to a remote computing device via an email.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a illustrative view of a fracking operation;

FIG. 2 is a diagrammatic view of one embodiment of a thermal monitoring system for monitoring the thermal conditions of a fracking pump according to an embodiment of the present disclosure;

FIG. 3 is a cross-sectional view of a portion of the fracking pump of FIG. 2 according to an embodiment of the present disclosure; and

FIG. 4 is a diagrammatic view of an indication system of the thermal monitoring system of FIG. 2 according to an embodiment of the present disclosure.

Like reference symbols in the various drawings indicate like elements.

### DETAILED DESCRIPTION OF THE PREFERRED EMBODIMENTS

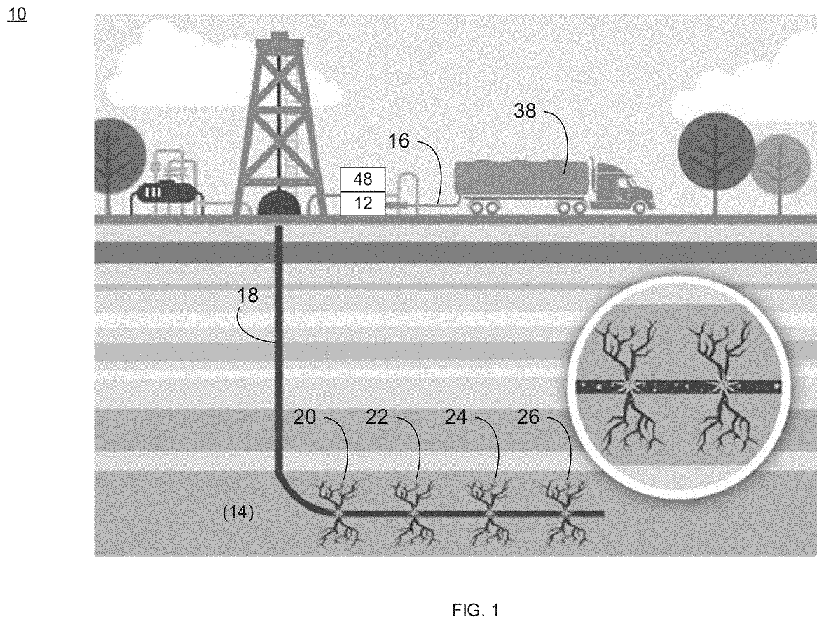

Referring to FIG. 1, there is shown fracking system 10. Fracking system 10 may include fracking pump 12 (sometimes referred to as a fluid end) configured for use with fracking operations. As discussed above, fracking is a well stimulation technique involving the fracturing of bedrock formations (e.g., bedrock formations 14) using a pressurized liquid (e.g., fracking fluid 16). The fracking process involves the high-pressure injection (@ 10,000-14,000 PSI) of fracking fluid 16 (primarily water, containing sand or other proppants suspended with the aid of thickening agents) into a well bore (e.g., well bore 18) to create fractures (e.g., fractures 20, 22, 24, 26) in the deep-rock formations (e.g., bedrock formations 14) through which natural gas and petroleum will flow more freely. When the hydraulic pressure is removed from the well bore (e.g., well bore 18), small grains of hydraulic fracturing proppants (either sand or aluminum oxide) hold the fractures open, thus allowing the continued flow of the natural gas and petroleum from the bore (e.g., well bore 18).

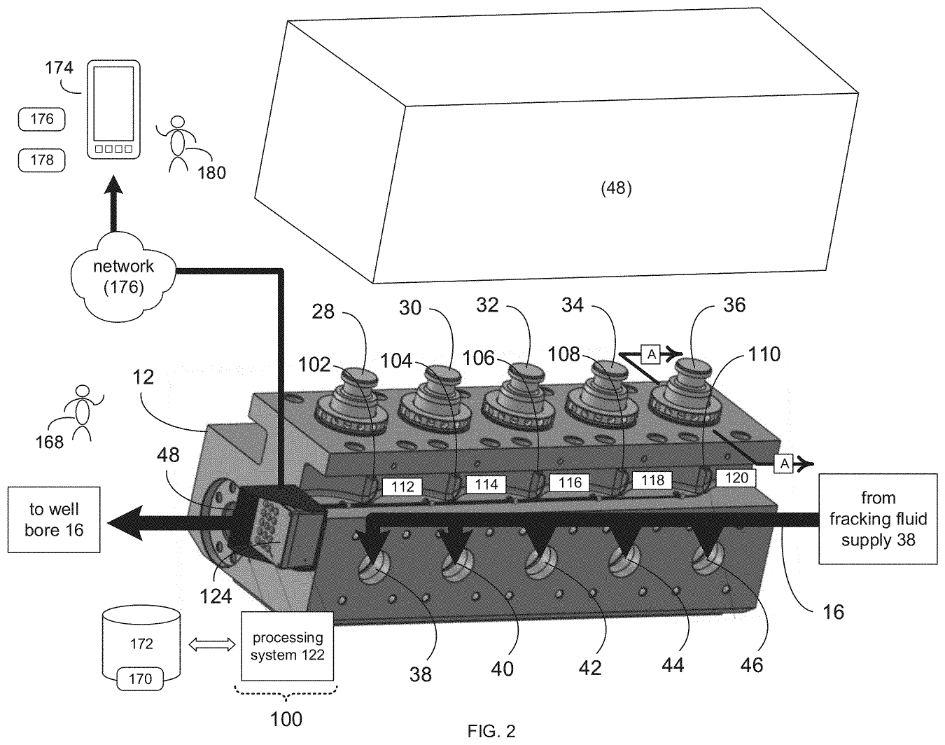

Referring also to FIG. 2, fracking pump 12 may include a plurality of plungers (e.g., plungers 28, 30, 32, 34, 36) that are configured to pressurize fracking fluid (e.g., fracking fluid 16) that is received from a fracking fluid supply (e.g., fracking fluid supply 38). Examples of fracking fluid supply 38 may include but are not limited to a tanker truck capable of transporting fracking fluid 16. Fracking fluid supply 38 may provide fracking fluid 16 to inlet ports 38, 40, 42, 44, 46 associated with plungers 28, 30, 32, 34, 36 (respectively), wherein plungers 28, 30, 32, 34, 36 may pressurize fracking fluid 16, which is made available via outlet port 48 to well bore 18.

Power system 48 (sometimes referred to as a power end) may be configured to provide power to fracking pump 12. Examples of power system 48 may include but is not limited to a diesel engine, a gasoline engine, and an electric motor. During operation, power system 48 may be configured to reciprocate plungers 28, 30, 32, 34, 36, resulting in the drawing of fracking fluid 16 into inlet ports 38, 40, 42, 44, 46 (during the suction portion of the reciprocating motion of plungers 28, 30, 32, 34, 36) and the subsequent expulsions of fracking fluid 16 from outlet port 48 (during the pressure portion of the reciprocating motion of plungers 28, 30, 32, 34, 36), wherein fracking fluid 16 (now pressurized) may be provided to well bore 18 to effectuate the above-described fracking operation.

Thermal monitoring system 100 may be configured to monitor the temperature of various portions of fracking pump 12. Thermal monitoring system 100 may include one or more thermal sensors (e.g., thermal sensors 102, 104, 106, 108, 110) configured to monitor the temperature of one or more portions of fracking pump 12. For example, the one or more thermal sensors (e.g., thermal sensors 102, 104, 106, 108, 110) may be positioned proximate the one or more plungers (e.g., plungers 28, 30, 32, 34, 36) within fracking pump 12. Thermal sensors 102, 104, 106, 108, 110 may be configured to monitor the temperatures proximate plungers 28, 30, 32, 34, 36 (respectively) and generate one or more thermal indication signals (e.g., thermal indication signals 112, 114, 116, 118, 120).

Thermal monitoring system 100 may include a processing system (e.g., processing system 122) configured to receive the one or more thermal indication signals (e.g., thermal indication signals 112, 114, 116, 118, 120) and associate the one or more thermal indication signals (e.g., thermal indication signals 112, 114, 116, 118, 120) with one or more operating temperatures of the one or more portions (e.g., plungers 28, 30, 32, 34, 36) of fracking pump 12.

Thermal monitoring system 100 may include an indication system (e.g., indication system 124) configured to provide a thermal condition indicator based, at least in part, upon the one or more operating temperatures of the one or more portions (e.g., plungers 14, 16, 18, 20, 22) of fracking pump 12.

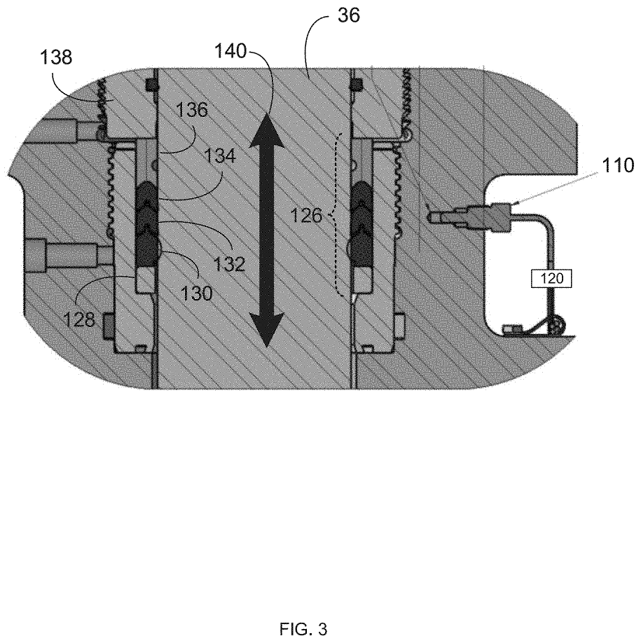

The one or more thermal sensors (e.g., thermal sensors 102, 104, 106, 108, 110) may be positioned proximate one or more packing assemblies associated with the one or more plungers (e.g., plungers 28, 30, 32, 34, 36) within fracking pump 12. Referring to FIG. 3, there is shown a cross-sectional view of fracking pump 12 (along section line A-A), illustrating plunger 36 and packing assembly 126. In this particular configuration, packing assembly 126 is shown to include ring assembly 128, seal assemblies 130, 132, 134 and bushing assembly 136, all of which are held in place by packing nut 138. Specifically, packing assembly 126 is a static packing assembly, wherein plunger 36 reciprocate (upward & downward) in the direction of arrow 140. Accordingly and in the configuration shown in FIG. 3, thermal sensor 110 is shown being positioned proximate packing assembly 126 so that the temperature of packing assembly 126 may be monitored (as defined by thermal indication signal 120 generated by thermal sensor 110).

The one or more thermal sensors (e.g., thermal sensors 102, 104, 106, 108, 110) may include one or more thermistor-based thermal sensors. As is known in the art, thermistors are a type of semiconductor (i.e., having a greater resistance than conducting materials but a lower resistance than insulating materials). The relationship between a thermistor's temperature and its resistance is highly dependent upon the materials from which it's composed. The manufacturer typically determines this property with a high degree of accuracy, as this is the primary characteristic of interest to thermistor buyers. Thermistors are made up of metallic oxides, binders and stabilizers, pressed into wafers and then cut to chip size, left in disc form, or made into another shape. The precise ratio of the composite materials governs their resistance/temperature “curve.” Manufacturers typically control this ratio with great accuracy, since it determines how the thermistor will function.

Accordingly and when the one or more thermal sensors (e.g., thermal sensors 102, 104, 106, 108, 110) include one or more thermistor-based thermal sensors, the one or more thermal indication signals (e.g., thermal indication signals 112, 114, 116, 118, 120) may include one or more resistance-based thermal indication signals, having a resistance that varies depending upon the temperature sensed by the thermal sensor (e.g., thermal sensors 102, 104, 106, 108, 110).

Alternatively, the one or more thermal sensors (e.g., thermal sensors 102, 104, 106, 108, 110) may include one or more thermocouple-based thermal sensors. As is known in the art, a thermocouple is a sensor that measures temperature that includes two different types of metals (joined together at one end). When the junction of the two metals is heated or cooled, a voltage is created that can be correlated back to the temperature of the thermocouple. Accordingly, a thermocouple is a simple, robust and cost-effective temperature sensor that may be used in a wide range of temperature measurement processes. Thermocouples may be manufactured in a variety of styles, such as thermocouple probes, thermocouple probes with connectors, transition joint thermocouple probes, infrared thermocouples, bare wire thermocouple or even just thermocouple wire.

Accordingly and when the one or more thermal sensors (e.g., thermal sensors 102, 104, 106, 108, 110) include one or more thermocouple-based thermal sensors, the one or more thermal indication signals (e.g., thermal indication signals 112, 114, 116, 118, 120) include one or more voltage-based thermal indication signals, having a voltage that varies depending upon the temperature sensed by the thermal sensor (e.g., thermal sensors 102, 104, 106, 108, 110).

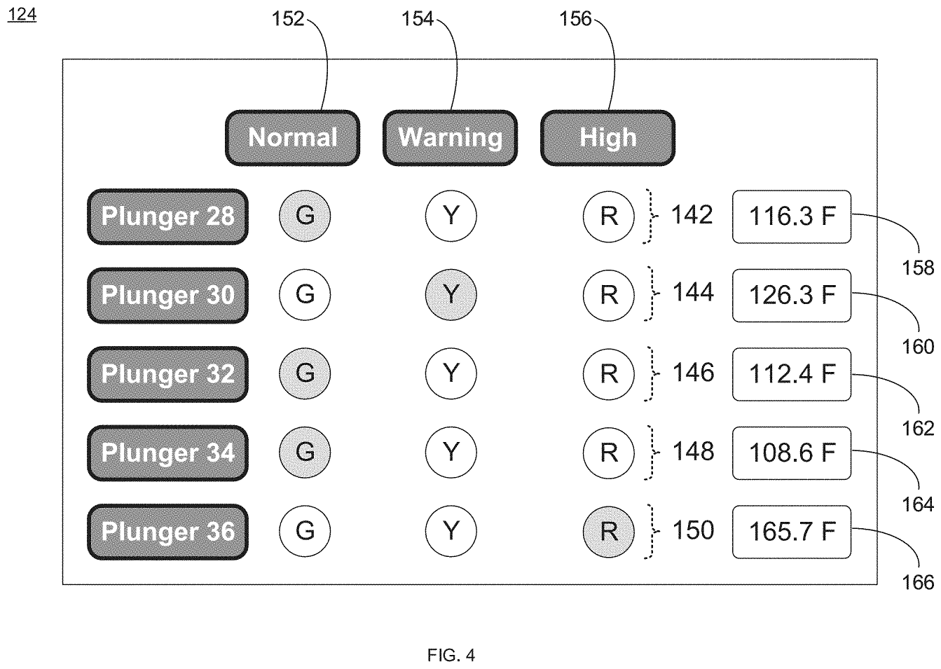

The indication system (e.g., indication system 124) may include one or more thermal operating range indicators. Specifically and referring also to FIG. 4, indication system 124 is shown to include five thermal operating range indicators (e.g., thermal operating range indicators 142, 144, 146, 148, 150), wherein thermal operating range indicators 142, 144, 146, 148, 150 correspond to the operating temperatures proximate plungers 28, 30, 32, 34, 36 (generally) and the temperatures of the packing assemblies (e.g., packing assembly 126) associated with each of plungers 28, 30, 32, 34, 36 (specifically).

In this particular example, indication system 124 is shown to include thermal operating range indicators 142, 144, 146, 148, 150, each of which includes three discrete indicators, namely: “normal” indicator 152 (e.g., a green LED or light), “warning” indicator 154 (e.g., a yellow LED or light), and “high” indicator 156 (e.g., a red LED or light).
For example, if the “normal” indicator for a particular plunger is illuminated, that particular plunger is operating in a normal thermal range (e.g., below 120 degrees Fahrenheit);
Further, if the “warning” indicator for a particular plunger is illuminated, that particular plunger is operating in an elevated thermal range (e.g., above 120 degrees Fahrenheit but below 160 degrees Fahrenheit); and
Additionally, if the “high” indicator for a particular plunger is illuminated, that particular plunger is operating in a high thermal range (e.g., above 160 degrees Fahrenheit).

Additionally, the indication system (e.g., indication system 124) may include one or more temperature indicators (e.g., thermal temperature indicators 158, 160, 162, 164, 166) that may indicate the actual temperatures of plungers 28, 30, 32, 34, 36 (respectively), wherein these temperature indicators (e.g., thermal temperature indicators 158, 160, 162, 164, 166) indicate that plungers 28, 32, 34 are operating in the “normal” range; plunger 30 is operating in the “warning” range; and plungers 36 is operating in the “high” range.

The various lights/LEDs/digital displays included within indication system 124 may be large enough to allow a person (e.g., user 168) proximate fracking pump 12 to determine the thermal operating condition of fracking pump 12 without needing to go near fracking pump 12 when it is operating (due to the very high operating pressures within fracking pump 12).

The processing system (e.g., processing system 122) may be configured to store temporal data (e.g., temporal data 170) based, at least in part, upon the one or more operating temperatures of the one or more plungers (e.g., plungers 28, 30, 32, 34, 36) of fracking pump 12. The temporal data (e.g., temporal data 170) may be stored on storage device 172 coupled to the processing system (e.g., processing system 122). Examples of storage device 172 may include but are not limited to: a hard disk drive; a random-access memory (RAM); a read-only memory (ROM); and all forms of flash memory storage devices. Examples of temporal data 170 may include time-based operating temperatures of the one or more plungers (e.g., plungers 28, 30, 32, 34, 36) of fracking pump 12, thus allowing a user (e.g., user 168) to examine and review the operating temperatures of plungers 28, 30, 32, 34, 36 over a defined period of time.

The processing system (e.g., processing system 122) may be configured to provide the temporal data (e.g., temporal data 170) to a remote computing device (e.g., remote computing device 174). Examples of remote computing device 174 may include but is not limited to: a desktop computer, a laptop computer, a tablet computer, and a smart telephone). The processing system (e.g., processing system 122) and the remote computing device (e.g., remote computing device 174) may be coupled via network 176, examples of which may include but are not limited to a wired network and a wireless network.

The processing system (e.g., processing system 122) may be configured to provide the one or more operating temperatures to a remote computing device (e.g., remote computing device 174). For example, the processing system (e.g., processing system 122) may be configured to provide the one or more operating temperatures to a remote computing device (e.g., remote computing device 174) via a text message (e.g., text message 176) and/or an email (e.g., email 178), either of which may be reviewed by a user (e.g., user 180) of remote computing device 174. Accordingly, user 180 may remotely monitor the thermal operating conditions of fracking pump 12 and may be proactively notified (via text message 176 and/or email 178) in the event that e.g., a plunger is operating in the elevated and/or high thermal range.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A thermal monitoring system comprising:
one or more thermal sensors configured to monitor the temperature of one or more portions of a fracking pump and generate one or more thermal indication signals;
a processing system configured to receive the one or more thermal indication signals and associate the one or more thermal indication signals with one or more operating temperatures of the one or more portions of the fracking pump; and
an indication system configured to provide a thermal condition indicator based, at least in part, upon the one or more operating temperatures of the one or more portions of the fracking pump.

2. The thermal monitoring system of claim 1 wherein the one or more thermal sensors are positioned proximate one or more plungers within the fracking pump.

3. The thermal monitoring system of claim 2 wherein the one or more thermal sensors are positioned proximate one or more packing assemblies associated with the one or more plungers within the fracking pump.

4. The thermal monitoring system of claim 1 wherein the one or more thermal sensors include one or more thermistor-based thermal sensors.

5. The thermal monitoring system of claim 4 wherein the one or more thermal indication signals include one or more resistance-based thermal indication signals.

6. The thermal monitoring system of claim 1 wherein the one or more thermal sensors include one or more thermocouple-based thermal sensors.

7. The thermal monitoring system of claim 6 wherein the one or more thermal indication signals include one or more voltage-based thermal indication signals.

8. The thermal monitoring system of claim 1 wherein the indication system includes one or more thermal operating range indicators.

9. The thermal monitoring system of claim 1 wherein the indication system includes one or more temperature indicators.

10. The thermal monitoring system of claim 1 wherein the processing system is configured to store temporal data based, at least in part, upon the one or more operating temperatures of the one or more portions of the fracking pump.

11. The thermal monitoring system of claim 10 wherein the processing system is configured to provide the temporal data to a remote computing device.

12. The thermal monitoring system of claim 1 wherein the processing system is configured to provide the one or more operating temperatures to a remote computing device.

13. The thermal monitoring system of claim 12 wherein the processing system is configured to provide the one or more operating temperatures to a remote computing device via a text message.

14. The thermal monitoring system of claim 12 wherein the processing system is configured to provide the one or more operating temperatures to a remote computing device via an email.

15. A thermal monitoring system comprising:
one or more thermal sensors configured to monitor the temperature of one or more portions of a fracking pump and generate one or more thermal indication signals, wherein the one or more thermal sensors are positioned proximate one or more plungers within the fracking pump;
a processing system configured to receive the one or more thermal indication signals and associate the one or more thermal indication signals with one or more operating temperatures of the one or more portions of the fracking pump; and
an indication system configured to provide a thermal condition indicator based, at least in part, upon the one or more operating temperatures of the one or more portions of the fracking pump, wherein the indication system includes one or more thermal operating range indicators.

16. The thermal monitoring system of claim 15 wherein the one or more thermal sensors are positioned proximate one or more packing assemblies associated with the one or more plungers within the fracking pump.

17. The thermal monitoring system of claim 15 wherein the processing system is configured to provide the one or more operating temperatures to a remote computing device.

18. The thermal monitoring system of claim 17 wherein the processing system is configured to provide the one or more operating temperatures to a remote computing device via a text message.

19. The thermal monitoring system of claim 17 wherein the processing system is configured to provide the one or more operating temperatures to a remote computing device via an email.

20. A thermal monitoring system comprising:
one or more thermal sensors configured to monitor the temperature of one or more portions of a fracking pump and generate one or more thermal indication signals, wherein:
the one or more thermal sensors are positioned proximate one or more packing assemblies associated with one or more plungers within the fracking pump,
the one or more thermal sensors include one or more thermocouple-based thermal sensors, and
the one or more thermal indication signals include one or more voltage-based thermal indication signals;
a processing system configured to receive the one or more thermal indication signals and associate the one or more thermal indication signals with one or more operating temperatures of the one or more portions of the fracking pump; and
an indication system configured to provide a thermal condition indicator based, at least in part, upon the one or more operating temperatures of the one or more portions of the fracking pump, wherein the indication system includes one or more thermal operating range indicators.

21. The thermal monitoring system of claim 20 wherein the processing system is configured to store temporal data based, at least in part, upon the one or more operating temperatures of the one or more portions of the fracking pump.

22. The thermal monitoring system of claim 21 wherein the processing system is configured to provide the temporal data to a remote computing device.

23. The thermal monitoring system of claim 20 wherein the processing system is configured to provide the one or more operating temperatures to a remote computing device.

24. The thermal monitoring system of claim 23 wherein the processing system is configured to provide the one or more operating temperatures to a remote computing device via a text message.

25. The thermal monitoring system of claim 23 wherein the processing system is configured to provide the one or more operating temperatures to a remote computing device via an email.
